(19) United States
(12) Patent Application Publication
(10) Pub. No.: US 2009/0051501 A1
(43) Pub. Date: Feb. 26, 2009

(54) METHODS AND SYSTEMS OF USING RADIO FREQUENCY IDENTIFICATION TAGS

(75) Inventor: John R. Tuttle, Boulder, CO (US)

Correspondence Address: GREENBERG TRAURIG, LLP (SV);IP DOCKETING, 2450 COLORADO AVENUE, SUITE 400E, SANTA MONICA, CA, 90404, US

(73) Assignee: MICRON TECHNOLOGY, INC., BOISE, ID (US)

(21) Appl. No.: 11/841,239

(22) Filed: Aug. 20, 2007

(51) Int. Cl. H04B 7/00

(52) U.S. Cl. 340/10.51; 186/61

(57) ABSTRACT

Method and system of using radio frequency identification tags. At least some of the illustrative embodiments are methods comprising receiving an item for purchase, reading RFID tag on the item to identify the item at checkout, and writing data to the RFID tag indicative of parameters associated with the purchaser.

### BACKGROUND

1. Field

At least some of the various embodiments are directed to using radio frequency identification (RFID) readers and RFID tags for post-purchase activities.

2. Description Of The Related Art

Several uses currently exist for radio frequency identification (RFID) tags. For example, RFID tagging can be used in a supply chain management applications (e.g. inventorying and tracking, predominantly at the pallet and case level). However, after an item is purchased or acquired, the RFID tag associated with that item becomes obsolete, either being permanently disabled, thrown away or not used again.

### BRIEF DESCRIPTION OF THE DRAWINGS

For a more detailed description of the various embodiments, reference will now be made to the accompanying drawings, wherein:

FIG. 1 illustrates a radio frequency identification (RFID) tag read/write system in accordance with various embodiments;

FIG. 2 illustrates a check-out system;

FIG. 3 illustrates a home computer with a RFID tag read/write device;

FIG. 4 is a flow diagram illustrating a method in accordance with at least some embodiments; and

FIG. 5 is a flow diagram illustrating a method in accordance with at least some embodiments.

### NOTATION AND NOMENCLATURE

Certain terms are used throughout the following description and claims to refer to particular system components. As one skilled in the art will appreciate, design and manufacturing companies may refer to the same component by different names. This document does not intend to distinguish between components that differ in name but not function. In the following discussion and in the claims, the terms “including” and “comprising” are used in an open-ended fashion, and thus should be interpreted to mean “including, but not limited to . . . .”

Also, the term “couple” or “couples” is intended to mean either an indirect or direct connection. Thus, if a first device couples to a second device, that connection may be through a direct connection or through an indirect connection via other intermediate devices and connections. Moreover, the term “system” means “one or more components” combined together. Thus, a system can comprise an “entire system,” “subsystems” within the system, a radio frequency identification (RFID) tag, a RFID reader, or any other device comprising one or more components.

### DETAILED DESCRIPTION

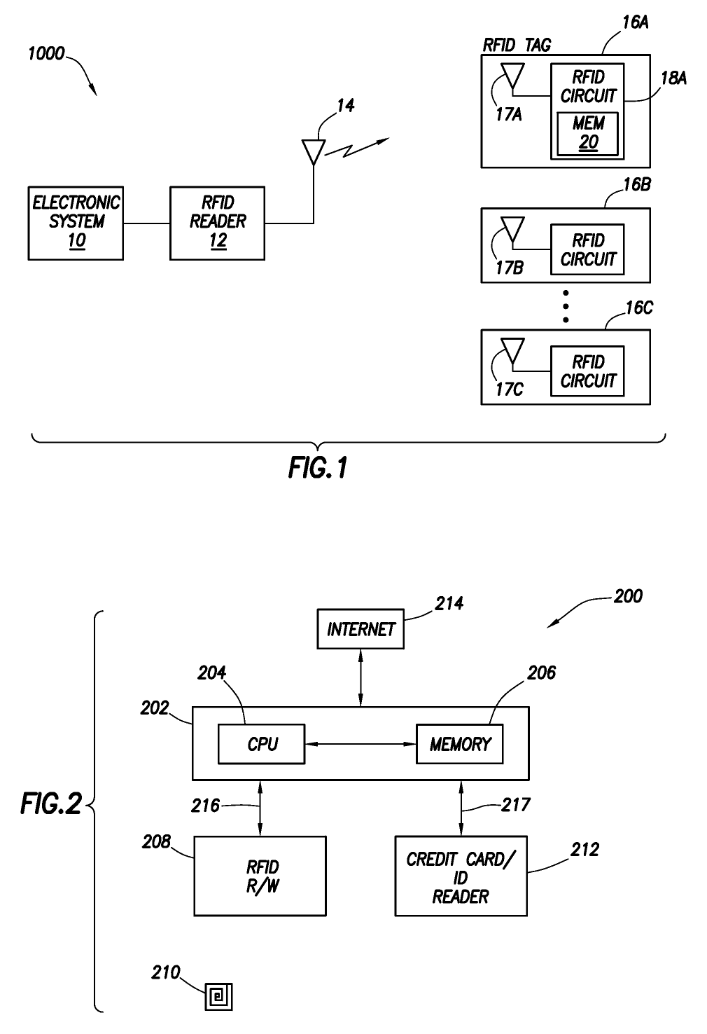

FIG. 1 illustrates a system 1000 in accordance with at least some embodiments. In particular, system 1000 comprises an electronic system 10 (e.g. a computer system) coupled to a radio frequency identification (RFID) reader 12. The RFID reader 12 may be equivalently referred as an interrogator. By way of antenna 14, the RFID reader 12 communicates with one or more RFID tags 16A-16C proximate to the RFID reader (i.e., within communication range).

Considering a single RFID tag 16A (but the description equally applicable to all the RFID tags 16A-16C), RFID tag 16A comprises a tag antenna 17A which couples to an RFID circuit 18A. The RFID circuit 18A implements in hardware (or a combination of hardware and software) various state machines, microprocessors, logic or other circuits to enable the RFID circuit to receive signals from the RFID reader, and to respond to those signals in accordance with the various embodiments. The RFID circuit 18A further comprises a tag memory 20 within which the data payload of the RFID tag may be stored (e.g. UPC codes for consumer purchasing activities, but also information about the consumer and/or useful to the consumer).

A communication sent by the RFID reader 12 is received by tag antenna 17A, and passed to the RFID circuit 18A. In response to the communication, the RFID circuit 18 transmits to the RFID reader 12 the response (e.g. the electronic product code, user defined data and kill passwords) using the tag antenna 17A. The RFID reader 12 passes data obtained from the various RFID tags 16 to the electronic system 10. The electronic system 10 may couple to the RFID reader by any suitable system, including over the Internet, and/or through other computers and computer networks. Using data obtained from the RFID reader 12, the electronic system may perform a variety of functions (e.g. the electronic system 10, based on the data received from the RFID tags 16, may add the item to a list of items to be purchased by the purchaser, or as discussed below the electronic system may use the information to assist the purchaser in activities such as registering the product).

There are several types of RFID tags operable in the illustrative system 1000. For example, RFID tags may be active tags, meaning each RFID tag comprises its own internal battery or other power source, and may comprise an active RF transmitter and/or RF beacon. Using power from the internal power source, an active RFID tag monitors for signals from the RFID reader 12. When an interrogating signal directed to the RFID tag is sensed, the tag response may be tag-radiated radio frequency (RF) power (with a carrier modulated to represent the data or identification value) using power from the internal battery or power source. A semi-active tag may likewise have its own internal battery or power source, but a semi-active tag remains dormant (i.e., powered-off or in a low power state) most of the time. When an antenna of a semi-active tag receives an interrogating signal, the power received is used to wake or activate the semi-active tag, and a response (if any) comprising an identification value is sent by modulating the RF backscatter from the tag antenna, with the semi-active tag using power for internal operations from its internal battery or power source. In particular, the RFID reader 12 and antenna 14 continue to transmit power after the RFID tag is awake. While the RFID reader 12 transmits, the tag antenna 17 of the RFID tag 16 is selectively tuned and de-tuned with respect to the carrier frequency. When tuned, significant incident power is absorbed by the tag antenna 17. When de-tuned, significant power is reflected by the tag antenna 17 to the antenna 14 of the RFID reader 12. The data or identification value modulates the carrier to form the reflected or backscattered electromagnetic wave. The RFID reader 12 reads the data or identification value from the backscattered electromagnetic waves.

A third type of RFID tag is a passive tag, which, unlike active and semi-active RFID tags, has no internal battery or power source. The tag antenna 17 of the passive RFID tag receives an interrogating signal from the RFID reader, and the power extracted from the received interrogating signal is used to power the tag. Once powered or “awake,” the passive RFID tag may accept a command, send a response comprising a data or identification value, or both; however, like the semi-active tag the passive tag sends the response in the form of RF backscatter.

The various embodiments are directed to systems for manipulating and using RFID tags for activities beyond supply chain management, such as post-purchase activities. FIG. 2 illustrates a retail check-out system 200 in accordance with various embodiments. In particular, FIG. 2 illustrates a computer in the form of a cash register 202 which comprises a processing unit (CPU) 204 and a memory 206. The cash register 202 is shown coupled to a RFID tag read/write device 208 by way of a coupling cable 216. The RFID read/write device 208 may have an operating range from a few centimeters to several meters, depending on the type of RFID tag used (e.g. active RFID tags, semi active RFID tags or passive tags). A RFID tag 210 is shown in operational relationship to the RFID tag read/write device 208, thus ensuring successful transmission of data between the RFID tag 210 to the RFID read/write device 208.

Still referring to FIG. 2, the cash register 202 is coupled to a credit card/ID card reader/keyboard 212 by way of a coupling cable 217. The card reader/keyboard 212 enables reading information regarding the purchaser of the item (e.g. name, address, credit card type, credit card number) and providing the information regarding the purchaser to the cash register 202. FIG. 2 further illustrates the cash register 202 coupled to a computer network 214 (e.g. the Internet, local area network, wide area network), thus enabling data received from the RFID read/write device 208 and the credit card reader/keyboard 212 to be transmitted to third parties, and vice-versa. In some embodiments, the cash register 202 is configured to write at least some of the information received from the reader/keyboard 212 regarding the purchaser to the RFID tag 210 by way of the RFID tag read/write device 208.

Consider a situation where a consumer or purchaser selects an item for purchase at a retail location. The purchaser takes the selected item to a check-out stand. At the check-out stand, the identity of the item to be purchased is established by reading the RFID tag 210 coupled to the object. Reading the RFID tag 210, the cash register 202 may either determine the price directly from the RFID tag, or the cash register may obtain a Universal Product Code (UPC), and the UPC may be correlated to price by reference to other computer systems coupled to the cash register 202 by way of the network 214.

In accordance with at least some embodiments, information regarding the purchaser is also obtained. Obtaining the information may take many forms. In some situations, a checker may inquire as the purchaser's identity, and the information may be supplied to the cash register 202 by way of an input/output device coupled to the CPU 204. In other embodiments, information about the purchaser may be established based on previous dealings with the customer (e.g. member information identified by a membership card in a wholesale club). In yet still other situations, information regarding the purchaser may be obtained by way of the credit card/ID reader 212 as the purchaser pays for item with a credit card. In other embodiments, obtaining information about the purchaser may be a combination of some or all of these mechanisms.

Rather than permanently disable or “kill” the RFID tag as dictated by some RFID tag protocols, in accordance with the various embodiments herein, at least some information regarding the purchaser may be written to the RFID tag 210 by way of the RFID tag read/write device 208 during the check-out process. In at least some embodiments, the information regarding the purchaser may be password-protected through a password associated with the purchaser. In other embodiments this information may be written to a write-protected bank of memory on the RFID tag 210. The purchaser information written may be useful, for example, in identifying ownership of the item, such as in a dispute over ownership. In addition to writing information regarding the purchaser to the RFID tag 210, other information may be written during check-out, such as information related to warranty registration (e.g. date of purchase, in-service date, or whether an upgraded or extended warranty or service plan has been purchased).

In some embodiments, the item may be immediately registered with the manufacturer at the time of purchase. When immediately registering, the cash register 202 gathers and organizes information for the registration process (e.g. product information (UPC, serial number) and purchaser information (name, address)) and transmits the information to the manufacturer, such as over the network 214. For example, the registration information may be formatted and sent to the manufacturer to by way of electronic-mail based or website based registration forms. Moreover in the immediate registration embodiments, in addition to writing information regarding the purchaser, the cash register 202 may also write warranty and/or service plan information to the RFID tag 210 (e.g. registration number, warranty expiration date, level of warranty coverage, uniform resource locator (URL) associated with terms and conditions of the warranty). Some or all the information written to the RFID tag 210 by the cash register 202 may be accessed by the purchaser at a later date, possibly through the use of a home or office RFID tag reader system 300.

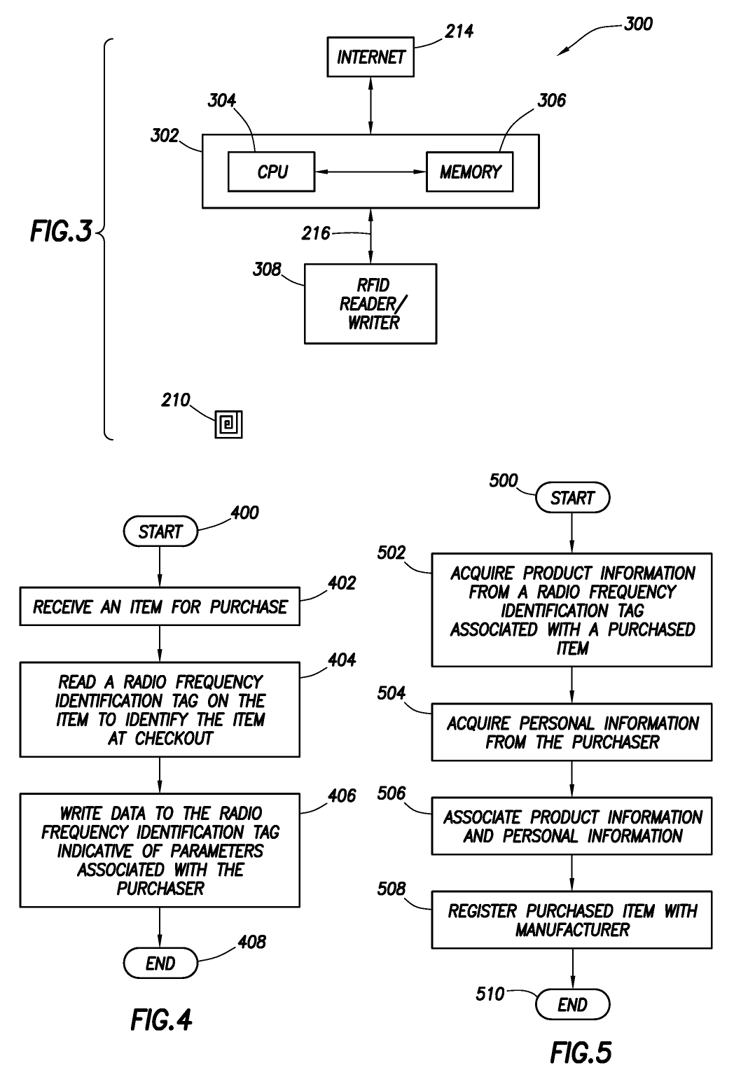

FIG. 3 illustrates a home/office RFID tag reader system 300 in accordance with various embodiments. In particular, FIG. 3 illustrates a home/office computer 302 which comprises a processing unit (CPU) 304 and a memory 306. The home/office computer 302 is coupled to a RFID tag read/write device 308 by way of a coupling cable 216. The home/office computer 302 is coupled to a computer network 214 (e.g., the Internet, local area network, wide area network), thus allowing data received from the RFID tag read/write device 308 to be transmitted to third parties, such as the manufacturer of the purchased item. In some embodiments, the home/office computer 302 may write data to the RFID tag 210, and assist the user with warranty registration process.

Consider a situation where a consumer or other purchaser has purchased an item tagged with a RFID tag, and has taken the item home or to the office. The RFID tag may be useful to the purchaser in the home/office in several respects. For example, if during the act of purchasing the item information no information about the purchaser was written to the RFID tag 210, using the system 300 the purchaser may write information to the RFID tag 210 e.g. name of owner, address of owner, or contact information). Moreover, in situations where the item was not immediately registered for warranty purposes during the check-out process, the warranty registration process by the purchaser may be aided by the RFID tag 210. In particular, once the purchaser has taken the product home or to the office, registration of the product may involve reading the RFID tag 210 with the RFID tag read/write device 308 coupled to the home/office computer 302. The reading of the RFID tag may perform several functions. In some embodiments, the RFID tag 210 stores a world-wide web address, and thus reading the tag automatically invokes the home/office computer 302 to open an Internet-browser program and access the web address. In at least some embodiments the web address may further comprise a web-based registration form. In such embodiments, the home/office computer 302 may be configured to populate at least some fields of the registration form automatically with data acquired from the RFID tag 210. Other fields which are not able to be automatically populated may be manually populated by the purchaser. Moreover, once registration is complete, some or all the warranty information may be written to the RFID tag by the home/office computer 302 (e.g. date of purchase, in-service date, whether an upgraded or extended warranty has been purchased, registration information, warranty contact information, or warranty expiration date).

FIG. 4 illustrates a method of writing information to a RFID tag 210 associated with a purchased item. In particular, the method starts (block 400) and proceeds to receiving an item for purchase (block 402). Thereafter, data is read from the RFID tag 210 associated with the purchased item to identify the purchased item at check-out (block 404). Information which is indicative of parameters associated with the purchaser is written to the RFID tag 210 (block 406), and the method ends (block 408). In some embodiments, data may be provided by the purchaser and written to the RFID tag 210 at the time of check-out. In other embodiments, data may be provided by the purchaser and written to the RFID tag 210 once the item is at the purchaser's home or office. In yet still other embodiments, the RFID tag may assist in registering the item for warranty purposes, and thus the information indicative of parameters associated with the purchaser may comprise not only purchaser specific information, but also information regarding the purchaser's warranty registration and related information. In some embodiments, the purchaser may write data to the RFID tag 210 by way of a household RFID tag read/write device.

FIG. 5 illustrates a method of using information acquired from a RFID tag 210 associated with a purchased item and information regarding the purchaser to satisfy product registration requirements. In particular, the method starts (block 500) and proceeds to acquiring product information from the RFID tag 210 associated with a purchased item (block 502), and acquiring personal information (e.g., information unique to the purchaser) from the purchaser (block 504). In some embodiments, product information may be acquired at home through the use of a household RFID tag reader system 300 or during the item check-out process. Additionally, information regarding the purchaser may be acquired through the use of a credit card/ID card reader 212, or through manual entry of information by the purchaser. Thereafter, the product information is associated with the personal information (block 506) to facilitate the registration of the purchased item with the item manufacturer. Finally, the purchased item is registered with the manufacturer (block 508), and the method ends (block 510). In some embodiments, the registration of the purchased item may be accomplished substantially simultaneous with the check-out process. In other embodiments, the registration of the purchased item may be accomplished by way of a home/office computer 302 coupled to a computer network 214 (e.g., the Internet, local area network, wide area network).

The above discussion is meant to be illustrative of the principles and various embodiments of the present invention. Numerous variations and modifications will become apparent to those skilled in the art once the above disclosure is fully appreciated. For example, in some embodiments the purchaser identification card may comprise an RFID tag, and thus obtaining information about the purchaser may involve reading the RFID tag of the purchaser's identification card. It is intended that the following claims be interpreted to embrace all such variations and modifications.

What is claimed is:

1. A method comprising:
receiving an item selected for purchase by a purchaser;
reading a radio frequency identification (RFID) tag on the item to identify the item at check-out; and
writing data to the RFID tag indicative of parameters associated with the purchaser.

2. The method as defined in claim 1 further comprising, prior to the writing, receiving from the purchaser personal information to be written to the RFID tag.

3. The method as defined in claim 1 wherein writing data further comprises writing data to the RFID tag during the check-out process.

4. The method as defined in claim 1 wherein writing data further comprises writing data to the RFID tag using a RFID read/write system in the purchaser's home or office.

5. The method as defined in claim 4 wherein writing data further comprises writing using a personal computer controlling a RFID tag read/write device.

6. The method as defined in claim 1 wherein writing data further comprises writing to the RFID tag at least one selected from the group consisting of: purchaser identification information; proof of ownership; purchase date; registration information; warranty contact information; warranty expiration date.

7. The method as defined in claim 1 wherein writing data further comprises storing the data in a write-protected bank of memory on the RFID tag.

8. The method as described in claim 1 wherein writing further comprises password-protecting at least some of the data stored on the RFID tag.

9. A method of registering a purchased item with the item's manufacturer, comprising:
reading a radio frequency identification tag (RFID) tag associated with the purchased item to obtain information specific to the purchased item;
obtaining information specific to the purchaser of the purchased item; and
providing to the manufacturer information specific to the purchased item and information specific to the purchaser.

10. The method as defined in claim 9 wherein registering further comprises registering to fulfill warranty requirements.

11. The method as defined in claim 9 wherein information specific to the purchaser further comprises at least one selected from the group consisting of: manually entering the information specific to the purchaser by the purchaser; retrieving the information specific to the purchaser from a purchaser's identification card; and retrieving information specific to the purchaser from a purchaser's credit card.

12. The method as defined in claim 9 wherein providing to the manufacturer further comprises sending an electronic registration form to the manufacturer through at least one selected from the group consisting of: electronic mail; and world-wide web-based registration form.

13. A system comprising:
means for reading a radio frequency identification (RFID) tag associated with a purchased item;
means for executing a computer program, the means for executing configured to:
acquire product information from the RFID tag associated with a purchased item;
acquire personal information from a purchaser of the purchased item;
associate the product information with the personal information; and
register the purchased item with at least one selected from the group consisting of: a manufacturer; a vendor; and a supplier.

14. The system as defined in claim 13 wherein the means for executing further comprises a means for acquiring personal information through at least one selected from the group consisting of: a prompt for user input; a purchaser identification card; and a purchaser credit card.

15. The system as defined in claim 14 wherein the purchaser identification card is a RFID tag containing personal information requisite to the product registration process.

16. The system as defined in claim 13 wherein the means for executing is further configured to format the product information and personal information to provide to a product registration form.

17. The system as defined in claim 13 wherein the means for executing is further configured to register via the Internet.

18. The system as defined in claim 13 wherein the means for executing is further configured to store purchaser information for product registration

19. A computer-readable media storing a program that, when executed by a processor, causes the processor to:
acquire product information from a radio frequency identification (RFID) tag associated with a purchased item;
acquire personal information from a purchaser of the purchased item;
associate the product information with the personal information; and
register the purchased item with at least one selected from the group consisting of: a manufacturer; a vendor; and a supplier.

20. The computer-readable media as defined in claim 19 wherein when the processor acquires product information the program causes the processor to acquire product information through a RFID tag read/write device.

21. The computer-readable media as defined in claim 19 wherein when processor acquires personal information the program causes the processor to acquire through at least one selected from the group consisting of: a prompt for user input; a purchaser identification card; and a purchaser credit card.

22. The computer-readable media as defined in claim 19 wherein when the processor associates the program causes the processor to format the product information and personal information for a product registration form.

23. A system comprising:
a radio frequency identification (RFID) reader configured to read an RFID tag associated with a purchased item;
an electronic system coupled to the RFID reader, the electronic system configured to:
acquire product information from the RFID tag associated with a purchased item;
acquire personal information from a purchaser of the purchased item;
associate the product information with the personal information; and
register the purchased item with at least one selected from the group consisting of: a manufacturer; a vendor; and a supplier.

24. The system as defined in claim 23 wherein the electronic system further comprises is further ea means for acquiring personal information through at least one selected from the group consisting of: a prompt for user input; a purchaser identification card; and a purchaser credit card.

25. The system as defined in claim 24 wherein the purchaser identification card is a RFID tag containing personal information requisite to the product registration process.

26. The system as defined in claim 23 wherein the electronic system is further configured to format the product information and personal information to provide to a product registration form.

27. The system as defined in claim 23 wherein the electronic system is further configured to register via the Internet.

28. The system as defined in claim 23 wherein the electronic system is further configured to store purchaser information for product registration
